(19) United States
(12) Patent Application Publication
(10) Pub. No.: US 2005/0044760 A1
(43) Pub. Date: Mar. 3, 2005

(54) Displaying graphics on a container

(75) Inventor: Geoffrey Terence Bailey, West Sussex (GB)

Correspondence Address: Arthur Jacob, 25 East Salem Street, P.O. Box 686, Hackensack, NJ, 07601, US

(73) Assignee: ORB Packaging UK Limited, Woodsetts (GB)

(21) Appl. No.: 10/654,374

(22) Filed: Sep. 3, 2003

(51) Int. Cl. G09F 3/00

(52) U.S. Cl. 40/310

(57) ABSTRACT

A method of displaying graphics on a conformation portion of a container, said conformation portion having a non-uniform cross-section therethrough, said method comprising the steps of a) arranging graphics with respect to a planar covering for said conformation portion, said graphics comprising graphics in distorted proportion to compensate for non-uniformity of said conformation portion, and b) performing a process of application in which said planar covering is applied to said conformation portion such that said graphics in distorted proportion appear in normal proportion. A planar covering for a conformation portion of a container, said conformation portion having a non-uniform cross-section therethrough, said planar covering comprising graphics in distorted proportion to compensate for non-uniformity of said conformation portion, whereby said graphics in distorted proportion are arranged to appear in normal proportion following a process of application of said planar covering to said conformation portion.

### BACKGROUND OF THE INVENTION

1. Field of the Invention

The present invention relates to a method of displaying graphics on a container, in particular a container comprising a non-uniform conformation portion.

2. Description of the Related Art

A first technique for displaying graphics on a container is to apply the graphics to the container by printing the graphics directly onto a surface of the container.

A second technique for displaying graphics on a container is to apply the graphics onto a label which is then secured to a surface of the container.

When utilising these techniques for displaying graphics on a non-uniform conformation portion of a container, complications are encountered due to the variation in the profile thereof.

### BRIEF SUMMARY OF THE INVENTION

According to a first aspect of the present invention, there is provided a method of displaying graphics on a conformation portion of a container, said conformation portion having a non-uniform cross-section therethrough, said method comprising the steps of a) arranging graphics with respect to a planar covering for said conformation portion, said graphics comprising graphics in distorted proportion to compensate for non-uniformity of said conformation portion, and b) performing a process of application in which said planar covering is applied to said conformation portion such that said graphics in distorted proportion appear in normal proportion.

According to a second aspect of the present invention, there is provided a planar covering for a conformation portion of a container, said conformation portion having a non-uniform cross-section therethrough, said planar covering comprising graphics in distorted proportion to compensate for non-uniformity of said conformation portion, whereby said graphics in distorted proportion are arranged to appear in normal proportion following a process of application of said planar covering to said conformation portion.

### BRIEF DESCRIPTION OF THE SEVERAL VIEWS OF THE DRAWINGS

FIG. 1 shows a container comprising a non-uniform conformation portion;

FIG. 2 shows a planar covering for application to the container shown in FIG. 1;

FIG. 3 shows graphics of the planar covering shown in FIG. 2 in further detail;

FIG. 4 shows the planar covering shown in FIG. 2 applied to the container shown in FIG. 1.

### WRITTEN DESCRIPTION OF THE BEST MODE FOR CARRYING OUT THE INVENTION

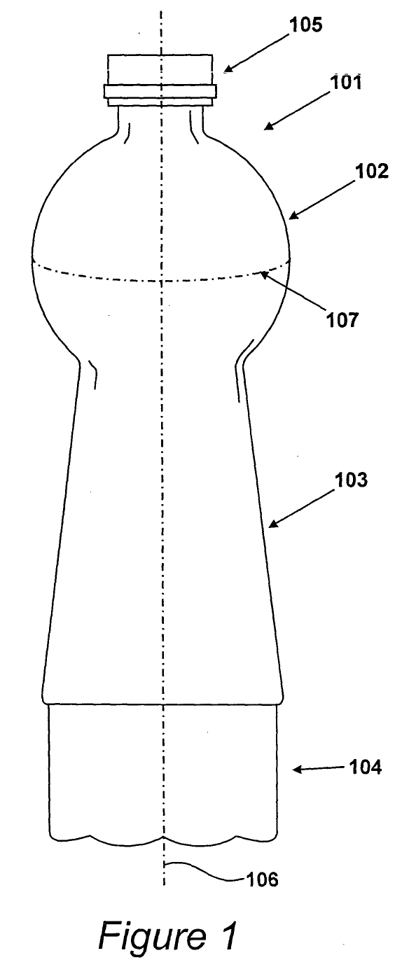

FIG. 1 shows a container comprising a non-uniform conformation portion. In this example, the container is a bottle 101. Bottle 101 comprises first and second non-uniform conformation portions 102, 103 respectively, a bottom portion 104 with a closed bottle bottom, and a top portion 105 with an open bottle top.

The first and second conformation portions 102, 103 each have a non-uniform cross-section therethrough. For example, observing the change in cross-section perpendicular to centre-line 106 through bottle 101, moving along centre-line 106 through each of the non-uniform conformation portions 102, 103; first conformation portion 102 has a substantially spherical bulge shape and second conformation portion 103 has a substantially truncated cone shape. The cross-section of first conformation portion 102 having the maximum radius is indicated by line 107, and this indicates the radius of the substantially spherical shape of this non-uniform conformation portion 102.

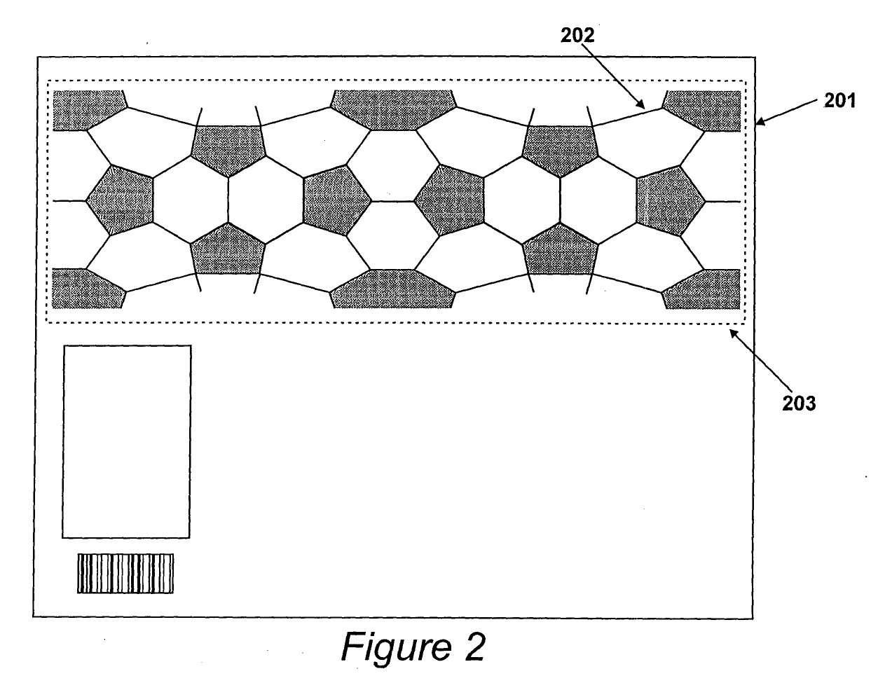

FIG. 2 shows an example of a planar covering for bottle 101, comprising graphics to be displayed on bottle 101. In the illustrated example, the planar covering is initially a substantially rectangular planar covering 201 arranged such that following a process of application of the covering 201 to bottle 101, the planar covering 201 is secured around bottle 101 and is substantially wrapped around each of the three portions 102, 103, 104 between the top and the bottom of the bottle 101; the planar covering 201 following the conformation contour thereof. As shown in FIG. 2, planar covering 201 comprises graphics 202 arranged with respect to planar covering 201, in a region indicated and enclosed by dotted line 203, such that following the process of application of planar covering 201 to bottle 101, graphics 202 are positioned and displayed on first non-uniform conformation portion 102. According to this illustrated example, graphics 202 are arranged to substantially cover non-uniform conformation portion 102.

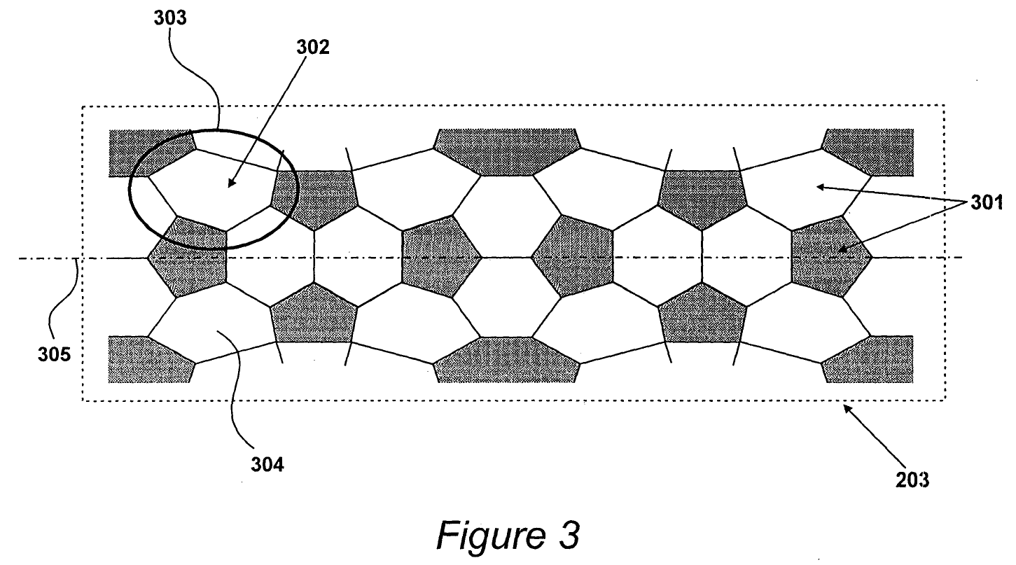

FIG. 3 shows graphics 202 in further detail. Graphics 202 is arranged such that following the application of covering 201 to bottle 101, graphics 202 displayed on first conformation portion 102 represents a football having regular hexagonal and regular pentagonal football sections.

As shown, graphics 202 in the region of planar covering 201 enclosed by dotted line 203 comprises a plurality of hexagonal and pentagonal football section representations 301 arranged in a 2-dimensional format. Due to the shape of first conformation portion 102, graphics 202 comprises graphics, for example graphics 302 in region 303, in distorted proportion to compensate for non-uniformity of first conformation portion 102. In this example, graphics 202, prior to the application of planar covering 202 to bottle 101, comprises football section representations, for example football section representation 304, that have a non-regular shape; in this example, non-regular hexagonal or pentagonal shape.

Planar covering 201 is arranged to be applied to bottle 101 such that the longitudinal centre-line 305 through graphics 202 is aligned with the line 107 shown in FIG. 1, indicating the radius of the substantially spherical shape of first conformation portion 102. It can be seen from FIG. 3 that the football section representations 301 lying on centre-line 305 are regular in shape. Moving away from centre-line 305 in a direction perpendicular thereto, it can be seen that the greater the distance from the centre-line 305, the more irregular the shape of the football section representation 301. Thus, graphics 202 is arranged such that there is an increase in degree of distorted proportion as the distance from centre-line 305 increases. This corresponds to the increase in curvature of the first conformation portion 102 as the perpendicular distance from the circumferential line 107 increases. Since, in this example, the shape of non-uniform conformation portion 102 is substantially regular, the change in degree of distorted proportion of graphics 202 is substantially mirrored about centre-line 305. Thus, graphics 202 in distorted proportion comprises different degrees of distorted proportion.

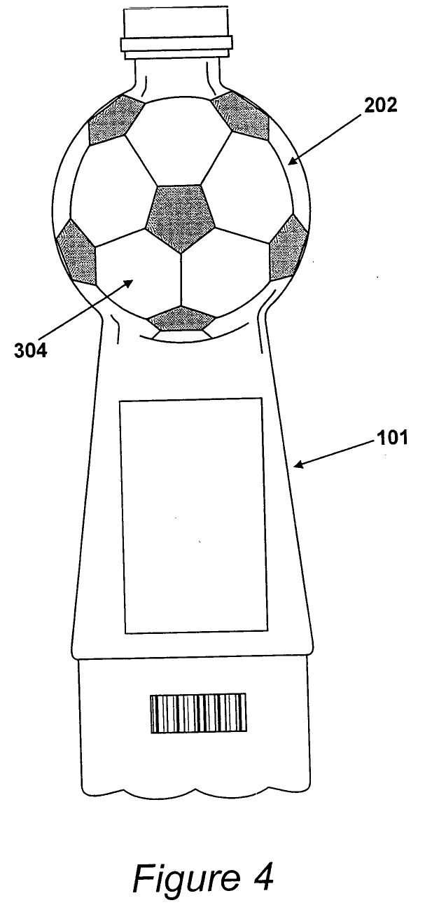

FIG. 4 shows planar covering 201 applied to bottle 101. It can be seen that following application of planar covering 201 to bottle 101, graphics 202 now displayed on non-uniform conformation portion 102 appear in normal proportion; taking into account normal perspective. Thus, referring to the region of planar covering 201 for conformation portion 102 only of bottle 101, the graphics in distorted proportion arranged with respect to the planar covering are arranged to appear in normal proportion following a process of application of the planar covering to the non-uniform conformation portion.

For example, previously irregular football section representation 304, appears regular and in normal proportion following the application of covering 201 to bottle 101. Thus, relative proportions of graphics 202 in distorted proportion are adjusted during the process of application of the covering 201 to bottle 101. As shown in FIG. 4, the result of the process of application is that the 2-dimensional distorted proportion representation of a football appears in a 3-dimensional shape in normal proportion.

An application process in which a degree of shape regularity or shape irregularity is removed is utilisable. An application process in which the degree of this effect varies with the profile of the non-uniform conformation portion is utilisable. Thus, the aforementioned variation in degree of distorted proportion of graphics 202, to compensate for different degrees of non-uniformity of first conformation portion 102, is similarly relevant to graphics in distorted proportion to compensate for a process of application. In this way, an effect of a process of application on graphics to be displayed on a non-uniform conformation portion of a container can be compensated.

An example of a process utilisable in the process of application is shrink-wrapping. For example, a planar shrink-wrap container covering having graphics applied thereto, for example by a printing process or other process suitable for affixing the graphics to a surface of the planar covering, is utilisable to display graphics, initially in a 2-dimensional form, on a 3-dimensional container having a non-uniform conformation portion.

Graphics of the type described herein, having graphics in distorted proportion, are arrangeable with respect to a planar covering to be applied to any shape or form of non-uniform conformation portion of a container. For example, the perimeter of a cross-section through a non-uniform conformation portion, perpendicular to a centre-line or other axis through the conformation portion, may define any regular or irregular shape, polygon or closed curve.

The container to which the planar covering is applied may be made from any suitable material, for example from plastic, glass or aluminium. The planar covering with respect to which the graphics in distorted proportion are arranged may be of a single or multilayer form. Thus, the graphics to be displayed on a container may be arranged with respect to an outer, inner or interleaved layer of the planar covering, or may be formed or contained within the planar covering. The graphics may be entirely or partially joined with the planar covering prior to the process of application or may be joined together during the process of application. The planar layer may be fabricated from plastic or any other material shapeable during a process of application. According to an alternative arrangement of planar covering and graphics to be displayed on a container, the planar covering is arranged to substantially cover a non-uniform conformation portion of a container whilst the graphics are arranged to partially cover the same non-uniform conformation portion. According to a further alternative arrangement of planar covering and graphics carried thereby, both the planar covering and the graphics are arranged to partially cover the same non-uniform conformation portion. Thus, a planar covering of any shape is utilisable to carry graphics to be displayed on a container.

1. A method of displaying graphics on a conformation portion of a container, said conformation portion having a non-uniform cross-section therethrough, said method comprising the steps of:
a) arranging graphics with respect to a planar covering for said conformation portion, said graphics comprising graphics in distorted proportion to compensate for non-uniformity of said conformation portion, and
b) performing a process of application in which said planar covering is applied to said conformation portion such that said graphics in distorted proportion appear in normal proportion.

2. A method as in claim 1 wherein said graphics in distorted proportion comprises different degrees of distorted proportion.

3. A method as in claim 1 in which the relative proportions of graphics in distorted proportion are adjusted during said process of application.

4. A method as in claim 3 in which said graphics in distorted proportion comprises shape regularity, a degree of which is removed during said process of application.

5. A method as in claim 3 in which said graphics in distorted proportion comprises shape irregularity, a degree of which is removed during said process of application.

6. A method as in claim 1 wherein said graphics are applied to said planar covering.

7. A method as in claim 6 wherein said graphics are printed onto said planar covering.

8. A method as in claim 1 wherein said process of application involves shrink-wrapping.

9. A method as in claim 1 wherein said conformation portion has a substantially spherical shape.

10. A planar covering for a conformation portion of a container, said conformation portion having a non-uniform cross-section therethrough, said planar covering comprising graphics in distorted proportion to compensate for non-uniformity of said conformation portion, whereby said graphics in distorted proportion are arranged to appear in normal proportion following a process of application of said planar covering to said conformation portion.

11. A planar covering as in claim 10 wherein said process of application involves shrink wrapping.

12. A container comprising a conformation portion having a non-uniform cross-section therethrough and a planar covering as in claim 10 applied to said conformation portion.
